(19) United States
(12) Patent Application Publication
(10) Pub. No.: US 2008/0002247 A1
(43) Pub. Date: Jan. 3, 2008

(54) DISPLAY UNIT

(75) Inventors: Hitoshi Nagato, Tokyo (JP); Rei Hasegawa, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/681,477

(22) Filed: Mar. 2, 2007

(30) Foreign Application Priority Data
Jun. 30, 2006 (JP) 2006-181436

(51) Int. Cl. G02B 26/08

(52) U.S. Cl. 359/222

(57) ABSTRACT

A display unit includes a prism layer comprising a light receiving surface, first facets extending along and facing with the light receiving surface, and second facets intersecting with the first facets, the first facets receiving incident light via the light receiving surface and reflecting them in a direction different from the light, and the second facets receiving light reflected by the first facets; first color layers placed on the second facets; a medium layer including a first medium that has a first refractive index causing total reflection of the light at a border between the first medium and the first facets, and a second medium that has a second refractive index enabling to pass through the light at a border between the second medium and the first facets, and the first and second media being movable in the medium layer; and a contact device configured to selectively bringing the first medium or the second medium into contact with the first facet.

### CROSS REFERENCE TO RELATED APPLICATIONS

This application is based upon and claims the benefit of priority from prior Japanese Patent Application 2006-181436 filed on Jun. 30, 2006, the entire contents of which are incorporated by reference herein.

### BACKGROUND OF THE INVENTION

1. Field of the Invention

This invention relates to a reflective display unit.

2. Description of the Related Art

Liquid crystal display units (LCD) are very thin compared with cathode ray tubes (CRT), and are widely applied to home use display units, display units for personal computers, laptop computers and so on, portable phones, digital cameras, video cameras, vehicle navigation units, or the like.

Liquid crystal display units including guest host liquid crystals are available. For instance, JP-A 2000-226584 (KOKAI) describes a liquid crystal display unit which uses guest host liquid crystals. In the liquid crystal display unit, liquid crystals including bicolor black coloring agents are stacked via glass substrates. Electrodes sandwiching a liquid crystal layer have the same potential in the liquid crystal display units. In such a case, molecules of the liquid crystals are oriented in every direction, so that bicolor black images appear. On the contrary, if a voltage is applied between the electrodes sandwiching the liquid crystal layer, longer axes of liquid crystal molecules are oriented vertically with respect to the liquid crystal layer. Light beams pass through the liquid crystal layer, are scattered by a scattering plate on a rear surface of the liquid crystal layer, and appear as white images. In short, the liquid crystal display unit using the guest host liquid crystals can selectively show bicolor images or images in a color which is determined on the rear surface of the liquid crystal layer.

Further, U.S. Pat. No. 5,959,777 describes a reflective display unit which employs a prism array structure. In this display unit, light beams are totally reflected between a prism array and an air layer. All of incident light beams are reflected by a reflective layer, and no color will appear. On the contrary, when a coloring agent is in close contact with the prism array, incident light beams are absorbed by the coloring agent, so that a colored will appear.

The foregoing reflective display units seem to have the following problems. If the guest host liquid crystals are used, a transparent state is not always complete. Colors (white and so on) shown by light beams passing through the liquid crystal layer tend to become dark. The reflective display unit preferably has a reflective index of at least 55% to 60% which is equal to a reflective index of a newspaper. In the case of the guest host liquid crystals, the display unit has a reflective index of approximately 40%. If the prism array is used, the display unit can have a reflective index of 60% or more because total reflection is carried out. However, since total reflection is carried out by specular reflection, the white color cannot appear because light beams are reflected, but the silver color due to specular reflection may sometimes appear.

With the guest host liquid crystal, a background color (white, for instance) can appear when light beams pass through the liquid crystal layer. In such a case, the reflective index is reduced. On the contrary, the reflective index is high in the prism array, and it is possible only to switch a no-color state over to a color state, and vice versa. It is very difficult to switch a current color over to a different color (for instance, white over to black, and vice versa).

The present invention has been contemplated in order to overcome problems of the related art, and is intended to provide a display unit which can switch colors while reflection coefficients are high.

### BRIEF SUMMARY OF THE INVENTION

According to a first aspect of the embodiment of the invention, there is provided a display unit including: a prism layer comprising a light receiving surface, first facets extending along and facing with the light receiving surface, and second facets intersecting with the first facets, the first facets receiving incident light via the light receiving surface and reflecting them in a direction different from the light, and the second facets receiving light reflected by the first facets; first color layers placed on the second facets; a medium layer including a first medium that has a first refractive index causing total reflection of the light at a border between the first medium and the first facets, and a second medium that has a second refractive index enabling to pass through the light at a border between the second medium and the first facets, and the first and second media being movable in the medium layer; and a contact device configured to selectively bringing the first medium or the second medium into contact with the first facet.

In accordance with a second aspect of the embodiment of the invention, there is provided a display unit including: a prism layer comprising a light receiving surface, first facets extending along and facing with the light receiving surface, and second facets intersecting with the first facets, the first facets receiving incident light via the light receiving surface and reflecting them in a direction different from the light, and the second facets receiving light reflected by the first facets; first color layers placed on the second facets; a liquid crystal layer in contact with the first facets; and a switch-over unit varying an orientation of liquid crystal of the liquid crystal layer and selectively putting the first facets in a reflection or pass-through state.

### BRIEF DESCRIPTION OF THE SEVERAL VIEWS OF THE DRAWINGS

Like or corresponding parts are denoted by like or corresponding reference numerals.

FIG. 1 is a block diagram of a display unit according to a first embodiment of the invention;

FIG. 2 is a cross section showing a configuration of an image display panel of the display unit in FIG. 1;

FIG. 3 is a cross section showing a further configuration of the image display panel of the display unit in FIG. 1;

FIG. 4 is a perspective view of a prism array and a substrate of the display panel of FIG. 2;

FIG. 5 is a cross section showing how light beams are reflected;

FIG. 6 is a cross section showing how light beams pass through a border between the prism array and the medium;

FIG. 7A is a cross section showing how a coating material, an adhesive or a resin material is applied all over the prism array in a first coloring process;

FIG. 7B is a cross section showing how the prism array is sandblasted in the first coloring process;

FIG. 7C is a cross section showing how the coating material is removed from an unnecessary part while the prism array is sandblasted in the first coloring process;

FIG. 8A is a cross section showing how a first color layer is formed by a further coloring process;

FIG. 8B is a cross section of the first color layer formed by the coloring process shown in FIG. 8A;

FIG. 9 is a cross section showing the first color layer formed by a still further coloring process;

FIG. 10 is a first modified example of the first embodiment;

FIG. 11 is a first modified example of the first embodiment;

FIG. 12 is a first modified example of the first embodiment;

FIG. 13 is a second modified example of the first embodiment;

FIG. 14 is a second modified example of the first embodiment;

FIG. 15 is a second modified example of the first embodiment;

FIG. 16 is a second modified example of the first embodiment;

FIG. 17 is a cross section of an image display unit according to a second embodiment; and

FIG. 18 is a cross section of an image display unit according to a third embodiment.

### DETAILED DESCRIPTION OF THE INVENTION

### First Embodiment

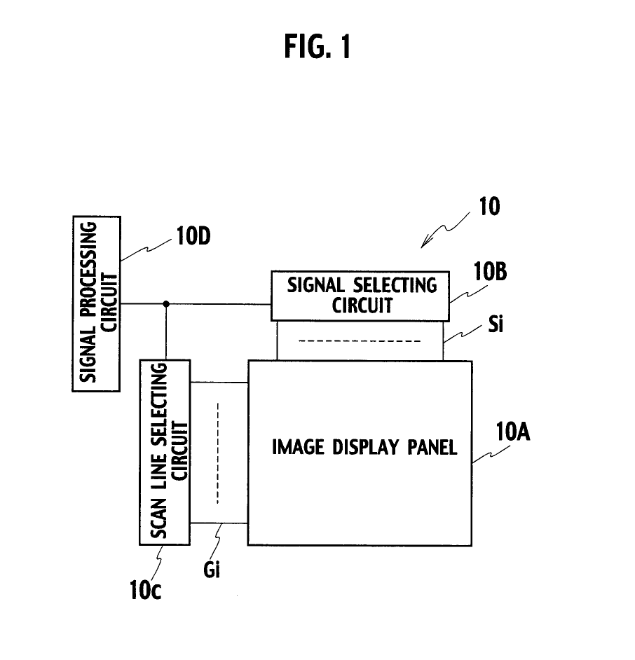

Referring to FIG. 1, an image display unit 10 includes an image display panel 10A, a signal line selecting circuit 10B, a scan line selecting circuit 10C, and a signal processing circuit 10D. The circuits 10B, 10C and 10D constitute a drive circuit. In the image display panel 10A, a plurality of sub-pixels are arranged in the shape of a matrix in such a manner that they correspond to intersections of signal lines Si and scan lines Gi. The letter “i” denotes a positive integer. The signal lines Si are connected to the signal line selecting circuit 10B while the scan lines Gi are connected to the scan line selecting circuit 10C. The signal line selecting circuit 10B and the scan line selecting circuit 10C are connected to the signal processing circuit 10D, and receive signals from the signal processing circuit 10D.

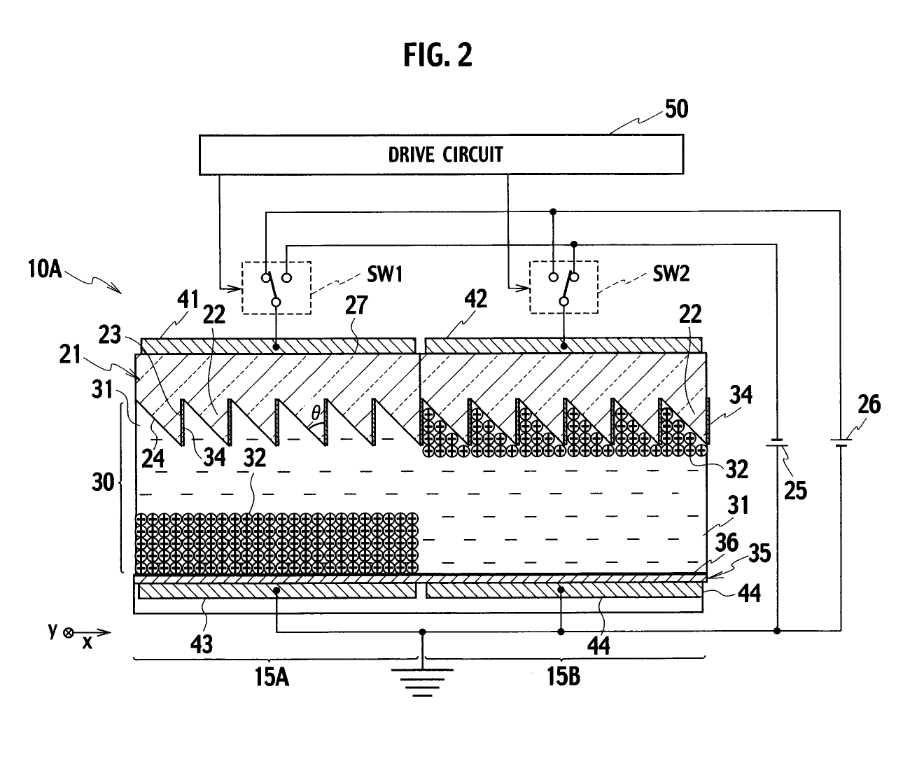

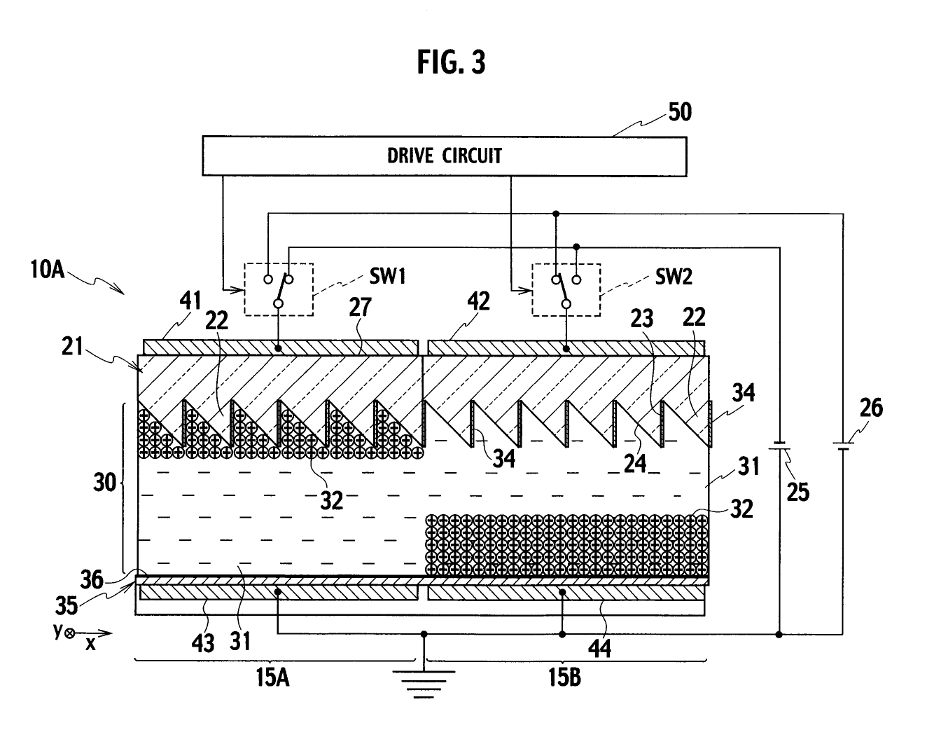

Refer to FIG. 2 and FIG. 3. The image display panel 10A further includes a prism array 21, a first color layer 34, a medium layer 30, and contact members (41, 42, 43 and 44).

The prism array 21 includes a light receiving surface 27 and a corrugated surface facing with the light receiving surface 27. The corrugated surface is constituted by a plurality of triangular prisms 22 whose refractive index is n₀. Each triangular prism 22 has a first facet (inclined facet 24), and a second facet (side facet 23). The inclined facets 24 face with a light receiving surface 27. The side facets 23 intersect with the inclined facets 24. The inclined facets 24 and side facets 23 are placed along the light receiving surface 27. The inclined facets 24 receive light beams (meaning light) via the light receiving surface 27, and reflect them in a direction different from a light coming direction. The side facet 23 receives light beams reflected by the inclined facets 24

The first color layer 34 is placed on the side facets 23. The medium layer 30 includes a first medium 31 and a second medium 32. The first medium 31 has a first refractive index causing total reflection of light beams at a border between the first medium and the inclined facets 24. The second medium 32 has a second refractive index enabling light beams to pass through a border between the second medium and the inclined facets 24. The first and second media 31 and 32 are freely movable in the medium layer 30. The contact members (41 to 44) selectively contact the first medium 31 or the second medium 32 onto the inclined facets 24.

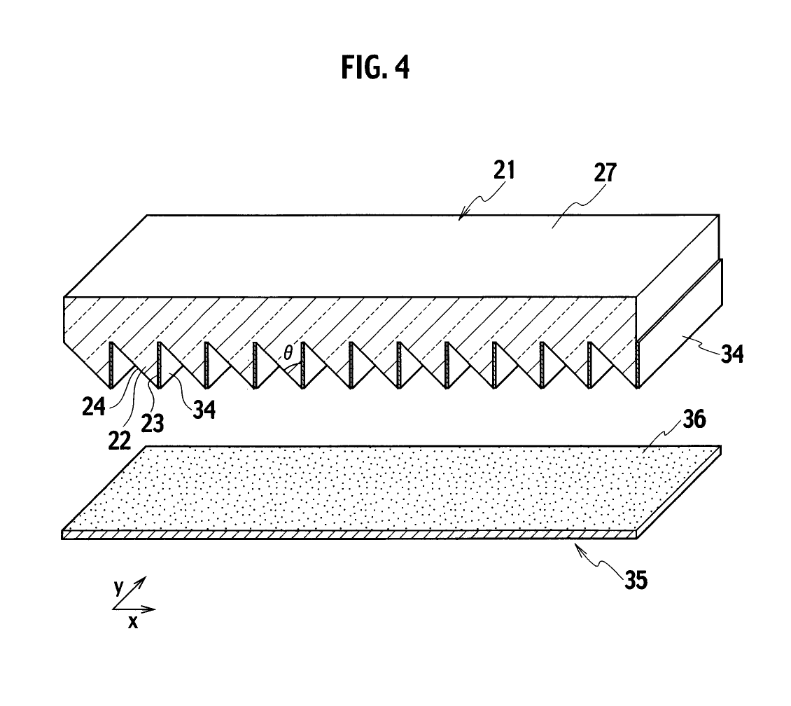

Referring to FIG. 4, each triangular prism 22 has an apex angle θ. The side facets 23 of the triangular prisms 22 are perpendicular to the light receiving surface 27. Further, the first color layer 34 is tinted in a certain color (white in this example). If the inclined facets 24 are not reflective (as will be described later), the color of the color layer 34 is not visible from the light receiving surface 27. This is because the side facets 23 are perpendicular to the light receiving surface 27.

A substrate 35 faces with the prism array 21, and has a second color layer 36 whose color is different from the color of the first color layer 34. In this example, the second color layer 36 is assumed to be black. The medium layer 30 (shown in FIG. 2 and FIG. 3) houses an insulating solvent (the first medium 31) in which fine resin particles (the second medium 32) are dispersed. The medium layer 30 is placed between the prism array 21 and the substrate 35.

The prism array 21 is provided with prism electrodes 41 and 42 (shown in FIGS. 2 and 3) for each pixel. Further, the substrate 35 includes electrodes 43 and 44 (shown in FIGS. 2 and 3). The prism electrodes 41 and 42 and the electrodes 43 and 44 are made of ITO (indium-tin oxide) or the like. Only two pixels 15A and 15B are depicted in FIG. 2 and FIG. 3. Actually, a plurality of pixels are two-dimensionally arranged on an xy-plane in order to form an image display screen. Switching circuits SW₁ and SW₂ are connected to the prism electrodes 41 and 42, and are designed to selectively operate a power source 25 or 26. The power sources 25 and 26 have opposite polarities. If the switching circuit SW₁ selects the power source 25, a voltage of the prism electrode 41 is lower than a voltage of the electrode 43. On the contrary, if the switching circuit SW₁ selects the power source 26, the voltage of the prism electrode 41 is higher than the voltage of the electrode 43. Further, if the switching circuit SW₂ selects the power source 25, a voltage of the prism electrodes 42 is lower than a voltage of the electrode 44. On the contrary, if the switching circuit SW₂ selects the power source 26, the voltage of the prism electrodes 42 is higher than the voltage of the electrode 44.

In the medium layer 30, transparent and fine resin particles 32 which are positively charged are uniformly dispersed in the insulating solvent 31. The fine resin particles 32 in an amount of approximately one weight % of the insulating solvent, and a charge controlling agent in approximately 10 weight % of the fine resin particles 32 are put into the insulating solvent 31, and are sufficiently dispersed using an ultrasonic cleaning unit. In this embodiment, the insulating solvent 31 is silicone oil, the fine resin particles 32 are made of an acrylic resin, and the charge controlling agent is made of zirconium naphthenate.

The voltages are applied to between the prism electrodes 41, 42 and the electrodes 43, 44 which sandwich the medium layer 30, so that fine resin particles 32 are controlled for the pixels 15A and 15B, respectively. Specifically, when the switching element SW₁ selects the power source 26, the prism array 21 has a high potential in the pixel 15A shown in FIG. 2. Therefore, fine resin particles 32 move toward the substrate 35 on which the electrode 43 is placed. In this state, the insulating solvent 31 is brought into contact with the inclined facets 24 of the prisms 22. Further, the switching element SW₂ selects the power source 25, and the prism array 21 has a low potential in the pixel 15B shown in FIG. 2. Therefore, fine resin particles 32 move toward the prism array 21. In this case, fine resin particles 32 come into contact with the inclined facets 24 of the prisms 22.

Selection of the switching circuit SW₁ or SW₂ is controlled by the drive circuit 50 (constituted by the signal processing circuit 10D, signal line selecting circuit 10B and scan line selecting circuit 10C (in FIG. 1)). The drive circuit 50 selects and controls the switching circuit SW₁ or SW₂ in accordance with s particular pixel, so that fine resin particles 32 related to the controlled switching circuit are moved toward the prism array 21 or the substrate 35. In order to make the pixels 15A and 15B independent, either of the electrodes 43 and 44 or the prism electrodes 41 and 42 should be separated. Further, one or more prisms 22 are present in one pixel. Since there is no restriction on a size of the prisms 22, approximately fifty (50) prisms 22 whose size is approximately 2μ may be arranged in a row in one pixel of approximately 100μ.

The prism array 21, insulating solvent 31 and fine resin particles 32 have different refractive indices. When the insulating solvent 31 is in contact with the inclined facets 24 of the prism array 21, the inclined facets 24 totally reflect light beams arriving via the light receiving surface 27. On the contrary, when fine resin particles 32 are in contact with the inclined facets 24, light beams will pass through the inclined facets 24.

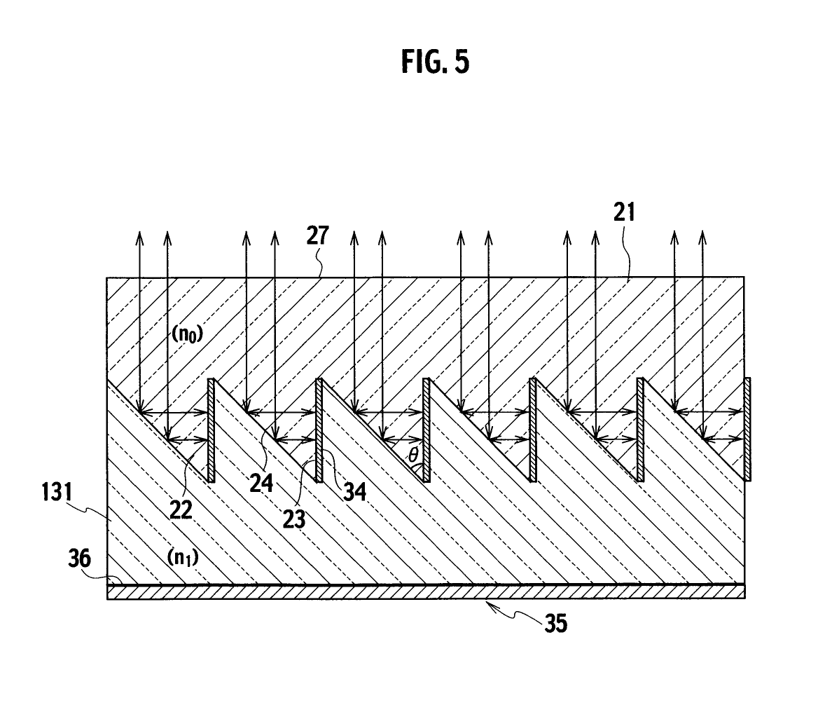

Referring to FIG. 5 and FIG. 6, when the prism array 21 whose prisms 22 have the refractive index n₀ is in contact with a medium 131 (having a refractive index n₁), light beams will be refracted at a border between the prism array 21 and the medium 131 (in this case, the border means the inclined facets 24) due to a difference between the refractive indices. For instance, an apex angle of each prism 22 is assumed to be 45° as shown in FIG. 5. Light beams arriving at the light receiving surface 27 at an angle of 90° will be totally reflected at the border so long as the refractive index of the medium 131 is smaller than n₀/(2^{(1/2)}). On the contrary, if the refractive index of the medium 131 is larger than n₀/(2^{(1/2)}), the light beams will pass through the border. FIG. 5 shows that total reflection is caused at the border (the inclined facets 24) between the prisms 22 and the medium 131 when the refractive index n₁ is smaller than n₀/(2^{(1/2)}). When total reflection is in progress, light beams arriving from above are laterally reflected, and illuminate white-colored side facets 23. Further, light beams scattered by the white-colored side facets 23 are subject to total reflection, and advance straight upward via a route which is the opposite direction of a route via which light beams arrive. In this state, the prism array 22 looks completely white when viewed from above (from the light receiving surface 27).

FIG. 6 shows a state in which light beams are prevented from total reflection at the border (the inclined facets 24) between the prisms 22 and the medium 131 because the refractive index n₂ is larger than the refractive index n₀/(2^{(1/2)}). In this case, light beams arriving from above are refracted on the inclined facets 24, pass through the insulating medium 131, and reach the second color layer 26. Light beams are scattered on the second color layer 36, and advance upward in a route which is the opposite direction of their incoming route. Light beams colored by the second color layer 36 can be viewed from above (the light receiver 27). When the second color layer 36 is black, substantially no light beams are reflected on the second color layer 36. The black color will be observed from above.

In the display panel 10A, the medium 131 is filled in the space between the prism array 21 and the electrode 35. Light beams are totally reflected or are made to pass through by varying the difference between the refractive indices of the medium 131 and the prism array 21. When light beams are totally reflected at the border, the color of the first color layer 34 can be observed on the side facets 23 of the prisms 22 where the color is not usually visible during total reflection. On the contrary, when light beam pass through the border, the color of the second color layer 36 on the electrode 35 is visible. The display unit 10 offers the black and white images. Although light beams are somewhat attenuated by the prisms 22, colored images are visible on the side facets 23 of the prisms 22 in an excellent state. In short, if the side facets 23 are colored white, very bright white images will appear. Compared with an existing guest host liquid crystal display unit, the reflective display unit can assure very bright images.

The display panel 10A shows images on the basis of the foregoing principle. The drive circuit 50 applies voltages to each pixel 15A and 15B in accordance with image data. For instance, when a voltage is applied to the pixel 15A in order to increase a potential of the prism electrode 41, positively charged fine resin particles 32 move toward the substrate 35, which enables the insulating solvent 31 to come into contact with the prism array 21. Refer to FIG. 2. The insulating solvent 31 is made of silicone oil whose refractive index is approximately 1.38, and the prism array 21 is made of glass whose refractive index is approximately 1.96. In this state, light beams will be totally reflected, so that white images will be visible from the light receiving surface 27. On the contrary, another voltage is applied to the pixels 15B in order to lower the potential of the prism electrode 42. In this case, positively charged fine resin particles 32 move toward and come into contact with the prism array 21. The fine resin particles 32 are made of an acrylic resin whose refractive index is approximately 1.5. Light beams are not reflected by the prism array 21 whose refractive index is approximately 1.96. Light beams pass through the border between the prism array 21 and the insulating solvent 31. In this state, the black color on the electrode 35 is visible from the light receiving surface 27. The fine resin particles 32 whose diameter is 100 nm or less is smaller than visible rays, and are not scattered, so that the black color layer 36 will be visible in a transparent state.

If the voltages applied to the prism electrodes 41 and 42 are switched over by switching circuits SW₁ and SW₂, fine resin particles 32 move toward the prism array 21 in the pixel 15A, so that the black color on the electrode 35 will be visible. Further, fine resin particles 32 move toward the electrode 35 in the pixel 15B and the insulating solvent 31 come into contact with the prism array 21, so that the white color on the side facets 23 of the prisms 22 will be visible.

The two colors can be alternately shown by using the medium layer 30 made of the fine resin particle dispersing solvent and by controlling the refractive indices of the media in contact with the prism array 21.

In the foregoing description, reflection and pass-through of light beams are switched over in accordance with the difference between the refractive indices of the charged transparent fine resin particles 32 and the insulating solvent 31. Alternatively, air or an inactive gas may be used in place of the insulating solvent 31 together with the charged transparent fine resin particles 32. In short, charged transparent resin particles 32 may be moved in the air using an electric field similarly to toner particles used for electro-photographic copying machines. Whenever fine resin particles 32 adhere to the prism array 21, light beams will pass through the border between the fine resin particles 32 and the prism array 21, fine resin particles 32 leave from the prisms 22, and the air come into contact with the prism array 21, so that light beams are totally reflected. The air has a refractive index of 1.0 which is the smallest, and enables total reflection of light beams. This promotes easy selection of materials for the prisms 22, and enlarges a viewing field.

In the examples shown in FIG. 2 and FIG. 3, the prism electrodes 41 and 42 are placed on the rear side of the prisms 22 (the light receiving surface 27). If each prism 22 is small, i.e., several μ, the electrodes 41 and 42 may be formed as described above. However, if one prism 22 constitutes one pixel, the prism 22 inevitably becomes tall. In such a case, if the electrodes are placed on the rear side of each prism 22 (the light receiving surface 27), a potential should be distributed to a large area. Therefore, the prism electrodes 41 and 42 should be mounted where the prism 22 is placed.

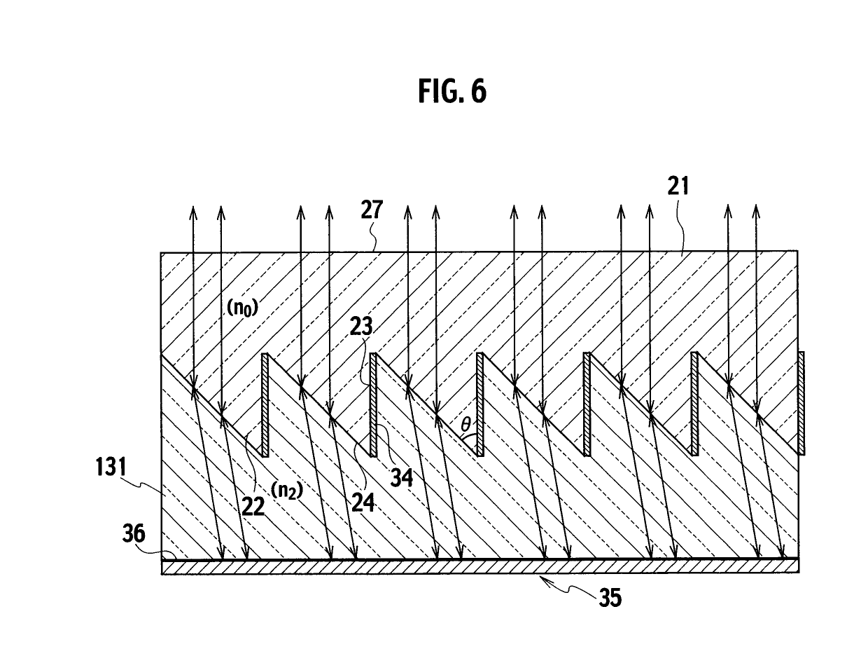

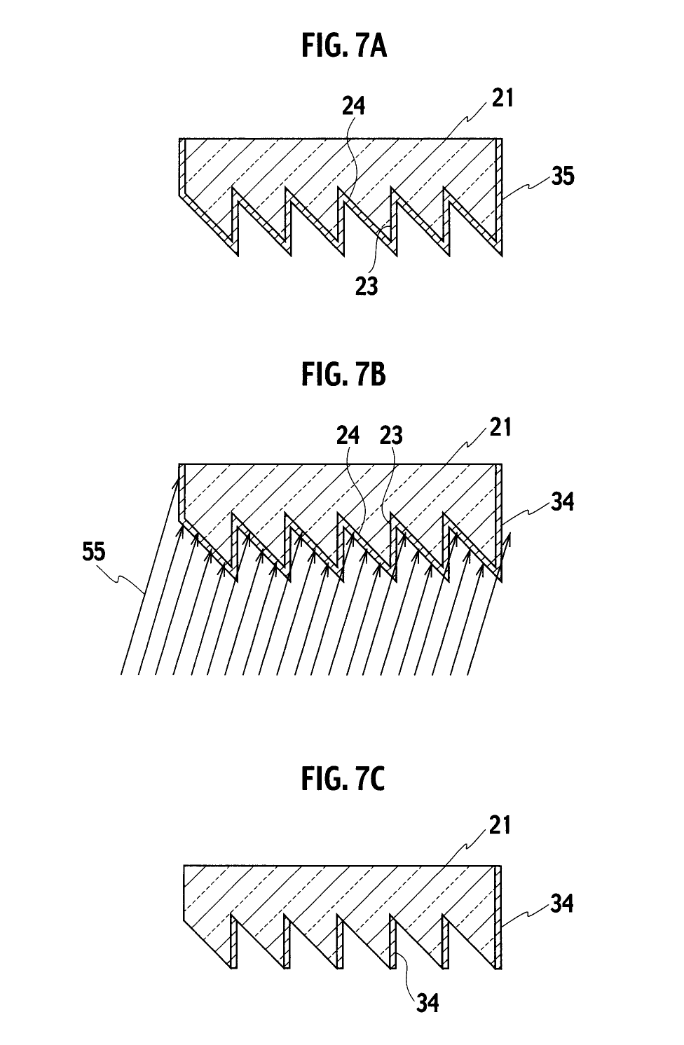

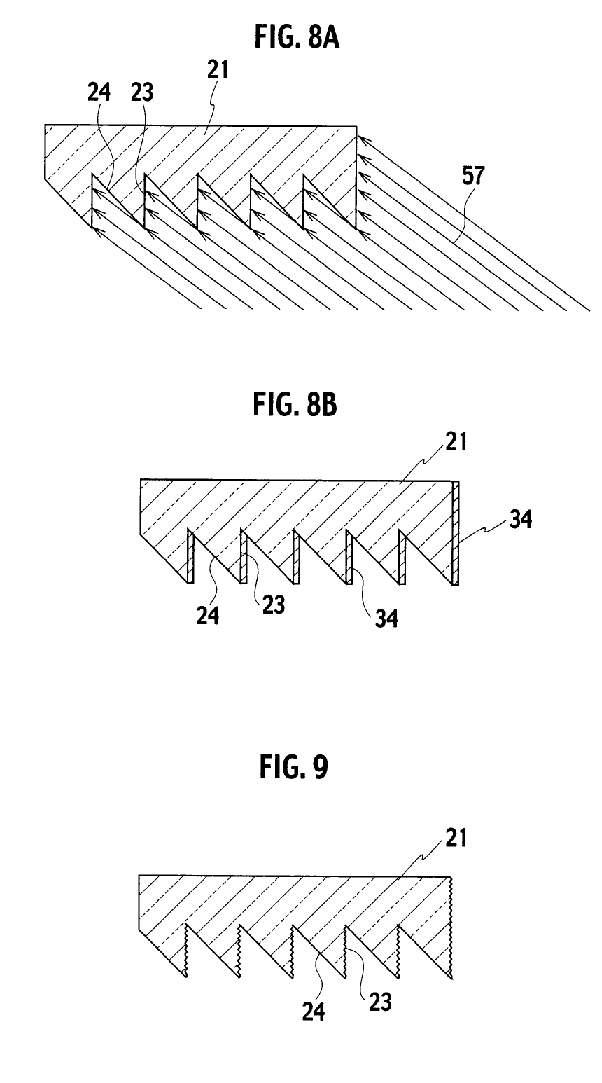

One example of coloring the prism array 21 will be described hereinafter with reference to FIG. 7A to FIG. 7C, FIG. 8A, FIG. 8B, and FIG. 9. Referring to FIG. 7A, paint 35, an adhesive or a resin having a first color is applied all over the prism array 21. Fine resin, ceramics or glass particles 55 are sand-blasted under pressure onto the inclined facets 24 of the prisms 22 as shown in FIG. 7B. In this case, the fine particles 55 are applied somewhat obliquely. This enables unnecessary paint 35 to be removed from the inclined facets 24 as shown in FIG. 7C. The fine particles 55 should be harder than paint 35 on the prisms 22, but should not damage the prisms 22. Therefore, the prism array 21 can have only the side (vertical) facets 23 of the prisms 22 colored. Refer to FIG. 7C.

Another example of coloring the prism array 21 is shown in FIG. 8A and FIG. 8B. A substance 57 having the first color is vacuum-evaporated or sputtered onto the prism array 21 from a direction which is inclined with an angle approximately equal to an angle of the inclined facets 24. Refer to FIG. 8A. The prism array 21 will have the side (vertical) facets 23 of the prisms 22 colored white as shown in FIG. 8B. The substance 57 may be zinc oxide. Further, the substance 57 may be metal particles in a size of approximately several hundred μm which is close to a wavelength of visible light. In such a case, the substance 57 can scatter light beams, so that the white color will appear.

Further, the white color can be shown simply by scattering light beams. For instance, fine particles which are harder than the prisms 22 may be sand-blasted onto the side facets 23 of the prisms 22 from the direction shown in FIG. 8A. In this case, the side facets 23 may be roughened as shown in FIG. 9, which enables the white color to appear when light beams are scattered on the side facets 23.

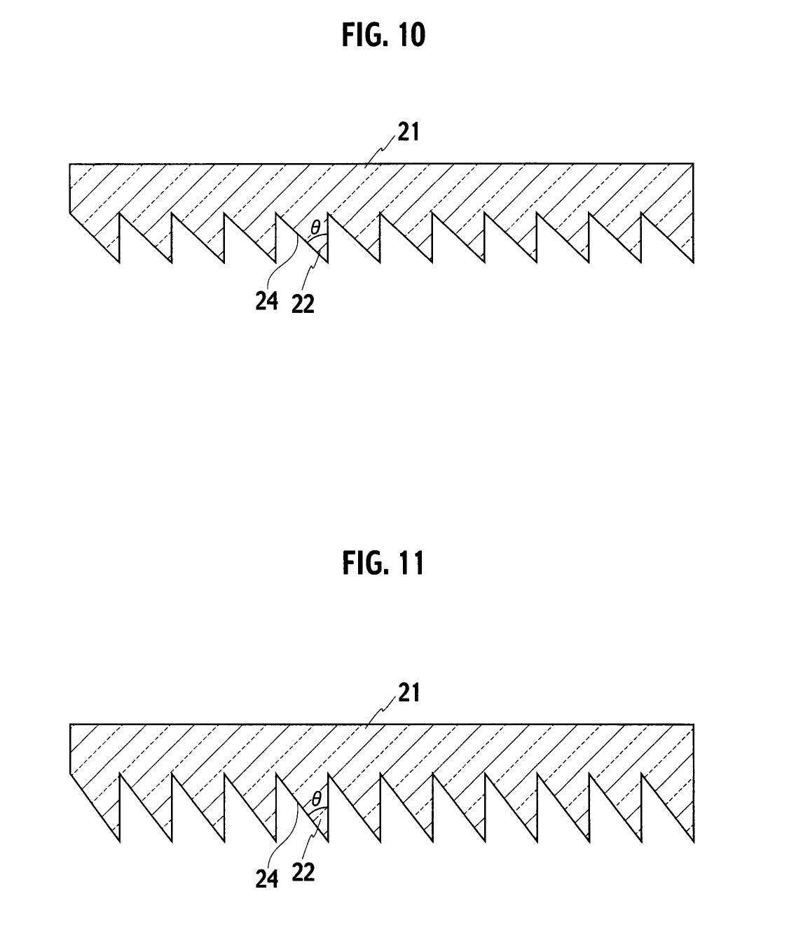

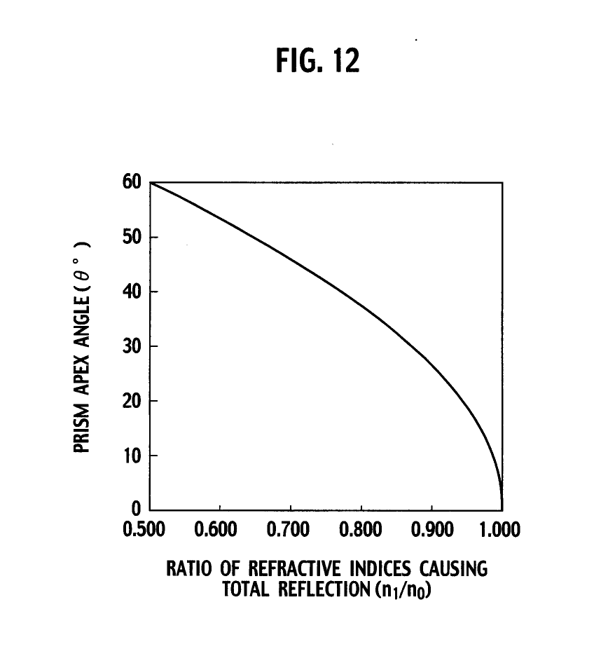

A first modified example of the first embodiment will be described with reference to FIG. 10 to FIG. 12. In the first embodiment, the apex angle θ of the prisms 22 is approximately 45 degrees as shown in FIG. 10. Alternatively, the apex angle θ may be smaller than 45 degrees, at least 25 degrees. Refer to FIG. 11. The smaller the apex angle θ, the more totally light beams are reflected on the inclined facets 24 of the prisms 22. FIG. 12 shows the relationship between apex angles and requirements for total reflection. In FIG. 12, the ordinate denotes apex angles of the prisms 22 while the abscissa denotes ratios of refractive indices necessary for total reflection, in which n₀ is the refractive index of the prisms 22, and n₁ is the refractive index of the medium which is in contact with the prisms 22 and causes the total reflection. For instance, if the apex angle is 45 degrees, the ratio of the refractive indices should be approximately 0.7. Silicone oil is assumed to used as the solvent, and to have a refractive index 1.36. A refractive index for the prisms 22 to cause total reflection is 1.94 (=1.36÷0.7). If the refractive index is as large as 1.94, substantially no resins are usable to make prisms. This means that either glass or special materials having a high refractive index should be used to make the prisms. On the contrary, if the apex angle is 25 degrees, the necessary ratio of the refractive index is 0.9 as shown in FIG. 12. In this case, when the prisms 22 are made of a material having a refractive index 1.51 (=1.36÷0.9), total reflection of light beams can be accomplished. Therefore, the prisms 22 may be made of commercially available reins such as acryl, polystyrene, and polyimide. In other words, when the apex angle is small, the refractive index n₀ of the prism material or refractive index n₁ of the medium in contact with the prisms can be set in wide ranges. This enables a variety of materials to be selected for the prisms, and the prisms to be produced at a relatively reduced cost. Further, it is assumed that the prisms 22 and the medium in contact with the prisms 22 are used in a variety of combinations. In such a case, if the apex angle is small, an incident angle which enables total reflection can be widened, and view angles can be enlarged.

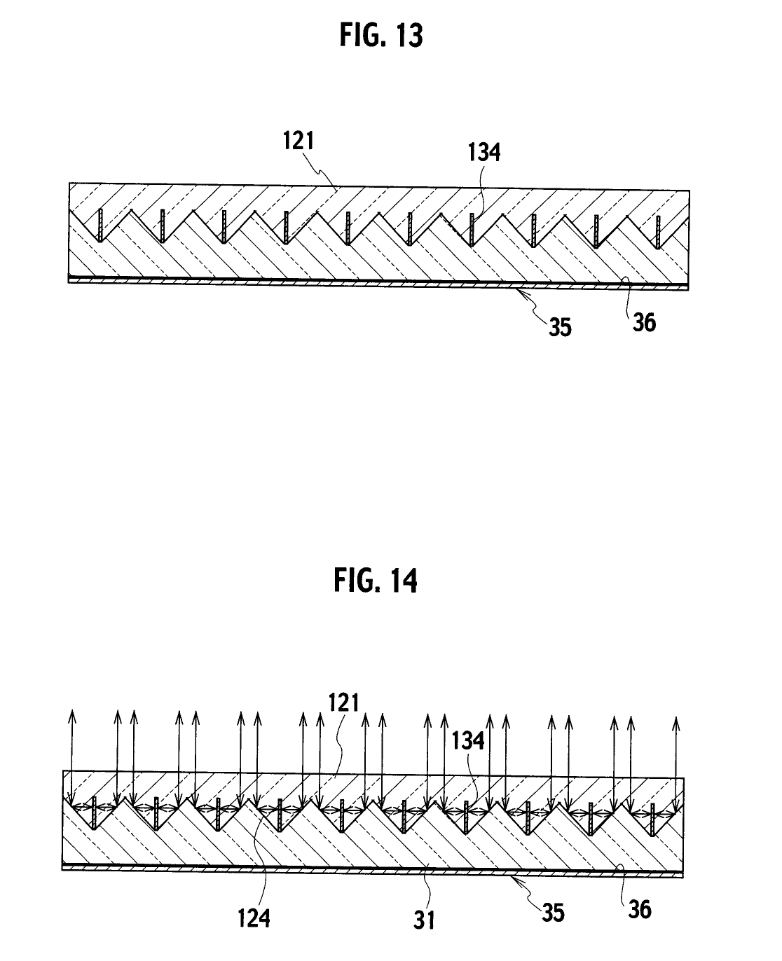

A second modified example of the first embodiment will be described with reference to FIG. 13 to FIG. 16. Referring to FIG. 13, a prism array 121 is constituted by prisms 22 (shown in FIG. 2). In this case, each second prism 22 is placed back to back. In short, each prism has 45° apex angle, so that every two prisms 22 placed side by side look so have an apex angle of 90°. The first color that is visible because of total reflection can be offered by coloring inner surfaces of slits 134 at the 90° apexes of the prism array 121. The prism array 121 is immersed in a colored adhesive or paint, which enables a colored agent to be filled in the slits 134 by capillary action. The colored agent is dried in the slits 134, and is cleaned from unnecessary parts of the prism array 121. Therefore, only the slits 134 are filled with the coloring agent.

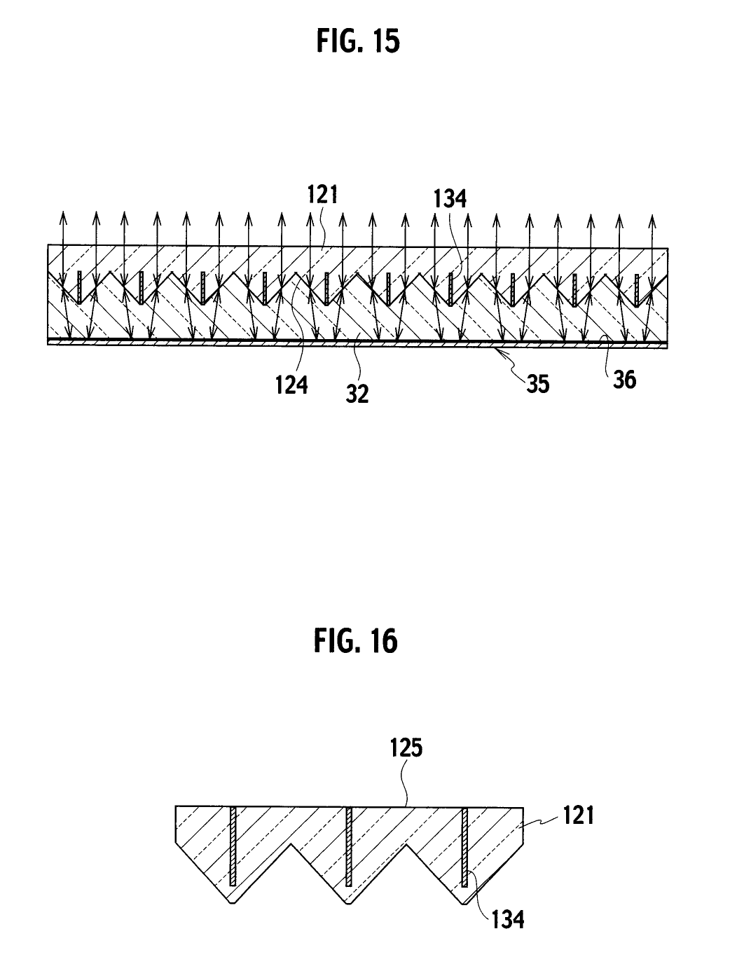

It is assumed here that the inner surfaces of the slits 134 are colored white while the surface 36 of the substrate 35 is colored black. The refractive index of the medium in contact with the prism array 121 is made smaller than the refractive index of the prism array 121 in order to accomplish total reflection. The white color of the slits 134 is visible as shown in FIG. 14 because of total reflection. On the contrary, if the refractive index of the medium in contact with the prism array 121 is made close to that of the prism array 121 in order to prevent total reflection, light beams will pass through the border (the inclined facets 124) of the prisms 22 as shown in FIG. 15, so that the black color of the surface 36 of the electrode 35 will be visible. Therefore, the white or black color is selectively visible.

Color layers (i.e., the slits 134) can be simply fabricated using the capillary action, compared with the example shown in FIG. 2. Further, the first color on the prisms 22 can be clearly shown. When the first color is white, it can be brightly shown. For instance, light beams arriving from above are totally reflected at the border 124 of the prisms 22 as shown in FIG. 14, and advance horizontally, and illuminate the white color in the slits 134. Light beams are scattered at white-colored parts of the slits 134. However, light beams scattered within angles for accomplishing total reflection will be reflected, so that the white color is visible. Since the coloring agent on the inner surfaces of the slits 134 is several μm to several ten μm thick, light beams which are scattered in the slits 134 advance through the rear surface of the prism array 121. With the prism array 12 shown in FIG. 2, such light beams will be lost. However, with the prism array 121, light beams will pass through prisms 22 which stand back to back, and advance outward, which enable the white color to be more brightly shown.

Referring to FIG. 16, the slits 134 may be made in a light receiving surface 125 of the prism array 121.

In accordance with the first embodiment, the two media 31 and 32 having the different refractive indices are selectively brought into contact with the prism array 21 (having a number of prisms 22) under electric control. Because of the relationship between the refractive indices of the prisms 22 and media 31 and 32, the color of the first color layer 34 on parts of the prisms 22 will be shown when the medium 31 causing total reflection is brought into contact with the prism array 21. Further, when the medium 32 is brought into contact with the prism array 21, light beams are not subject to total reflection, pass through the border between the medium 32 and the prisms 22, and show the color of the second color layer 36. In the reflective display unit having such a configuration, the colors can be selectively shown with the high reflective indices. In such a case, light beams will be lost only due to attenuation caused by material. For instance, when the first color layer 34 is white, a large reflective display unit can assure very bright and high contrast images.

### Second Embodiment

In the first embodiment, one of the media which are present between the prism array 21 and the substrate 35 is selectively used in order to totally reflect light beams or to enable light beams to pass through the border (the inclined facets 24). In the case of total reflection, the color of the first color layer 34 applied onto the side facet 23 of the prism array 21 will appear. When light beams pass through the prism array 21, the color of the second color layer 36 on the substrate 35 will appear.

In a second embodiment, the medium (insulating solvent 31) in contact with the prism array 21 has a low refractive index. When light beams are totally reflected, the color of the first color layer 34 on the side facets 23 of the prisms 22 will be shown. Further, when colored medium (fine resin particles 132) is in direct contact with the prisms 22, the second color of the fine resin particles 132 will be shown.

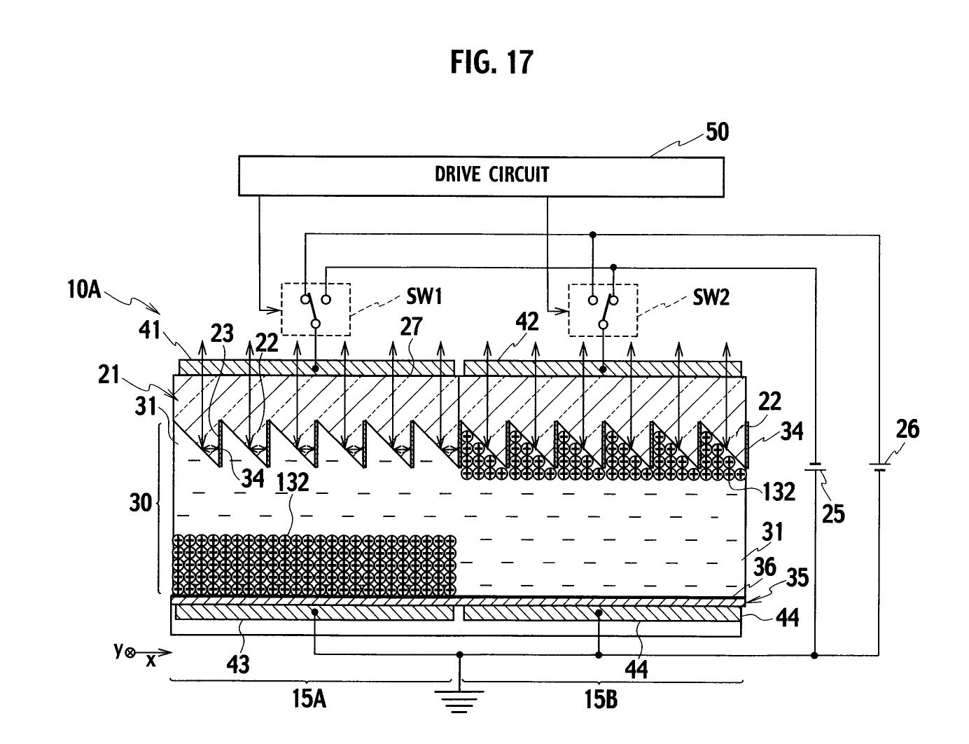

Referring to FIG. 17, a display unit 10 is similar to the display unit 10 of the first embodiment, but is different in the following respects: the medium layer 30 includes charged and colored fine resin particles 132 (in place of the transparent fine resin particles 32 in the first embodiment) and an insulating solvent 31. The medium layer 30 is filled in a space between the prism array 21 and the electrode 35. For instance, black fine resin particles 132 are uniformly dispersed in the insulating solvent 31.

The medium layer 30 is prepared by applying the following into the insulating solvent 31: the fine resin particles 132 in approximately one weight % of the insulating solvent and a charge controlling agent and a pigment which are approximately 10 weight % of the fine resin particles 132. All of the foregoing substances are sufficiently diffused using an ultrasonic cleaner or the like. In this case, the insulating solvent 31 is silicone oil; the fine resin particles 32 are made of an acrylic resin; and the charge control agent is zirconium naphthenate.

The pixels 15A and 15B are shown in FIG. 17. Each pixel 15A (or 15B) is constituted by an electrode 43 (or 44) and a prism electrode 41 (or 42). The fine resin particles 132 are controlled for the pixel 15A (or 15B) by applying voltages between the electrodes 43 and 41 (or 44 and 42). In order to make the respective pixels independent, either the electrode 43 (44) or the prism electrode 41 (or 42) should be separated. One or more prisms are present in one pixel. Further, there is no limit on a size of prisms 22. If each prism is approximately 2 μm, approximately fifty prisms 22 are juxtaposed in one pixel which is approximately 100 μm,

Voltages are applied to each pixel 15A and each pixel 15B in accordance with image data. For instance, when a voltage is applied to the pixel 15A (shown in FIG. 17) in order to raise a potential of the prism electrode 41, positively charged fine particles 132 move toward the substrate 35, and the insulating solvent 31 are brought into contact with the prism array 21. It is assumed that the insulating solvent 31 is made of silicone oil and has the refractive index of approximately 1.38. If the prism array 21 is made of glass whose refractive index is approximately 1.96, light beams will be totally reflected. This allows the white color to be observed from the light receiving surface 27. On the contrary, a voltage is applied to the pixel 15B (shown in FIG. 17) in order to reduce a potential of the prism electrode 42. In this case, positively charged fine resin particles 132 move toward and come into contact with the prism array 21. The fine resin particles 132 are made of the acrylic resin whose refractive index is approximately 1.5. If the prism array 21 is made of glass whose refractive index is approximately 1.96, light beams are not reflected but pass through the border between the prisms 22 and the fine resin particles 132. Therefore, the black color on the fine resin particles 132 will be observed at the light receiving surface 27. Further, when colored fine particles 132 are directly brought into contact with the prism array 21, the foregoing relationship between the refractive indices are not required to be strictly observed for the following reasons. Since the coloring agent on the fine resin particles 132 is in direct contact with the prisms 22, the color of the fine resin particles 132 can be shown even when the refractive index of the resin particles 132 satisfies the requirement for total reflection. The use of the medium layer (fine resin particle dispersing solvent) enables the first color on the side facets 23 of the prisms 22 or the second color of the fine resin particles 132 to be selectively shown.

The charged and colored fine resin particles 132 and insulating solvent 31 are used in the foregoing embodiment. Alternatively, the insulating solvent 31 may be replaced by air or an inert gas, which may be used together with the charged and colored fine resin particles 132. In other words, the charged and colored fine resin particles 132 are moved in the air using an electric field similarly to toner powder used for an electro-photographic copying machine. The color of fine resin particles 132 adhering to the prism array 21 will be shown. Further, when the fine resin particles 132 leave from the prism array 21, and when air is in contact with the prism array 21, light beams will be totally reflected. A refractive index of air is 1.0 which is the smallest of all, and facilitates total reflection of light beams. This is effective in easy selection of a prism material, and in enlarging a view angle.

In the second embodiment, either the first color of the color layer 34 of the prisms 22 or the color of the fine resin particles 32 is selectively shown, i.e., the colors can be switched while the reflective indices are high. Therefore, a large reflective display unit can assure bright and high contract images.

### Third Embodiment

In the first embodiment, one of the media which are present between the prism array 21 and the substrate 35 is selectively used in order to totally reflect light beams or to enable light beams to pass through the border (the inclined facets 24). In the case of total reflection, the color of the first color layer 34 applied onto the side facet 23 of the prism array 21 will appear. When light beams pass through the prism array 21, the color of the second color layer 36 on the substrate 35 will appear.

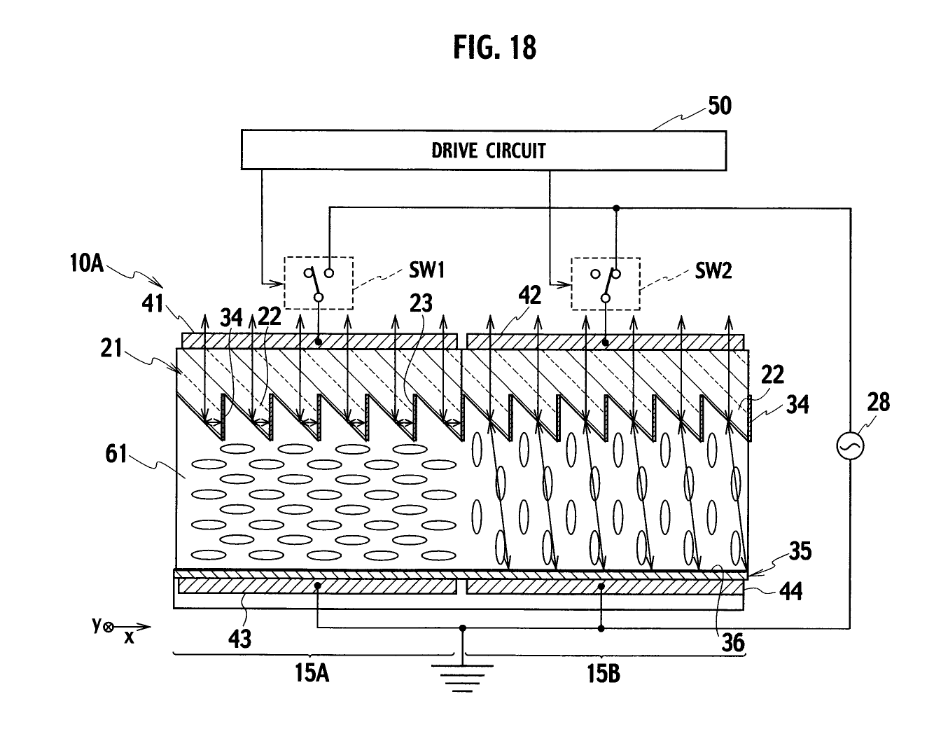

In a third embodiment, liquid crystals 61 fill a space between the prism array 21 and the substrate 35 as shown in FIG. 18. The liquid crystals 61 vary their orientations, and changes their refractive index, thereby totally reflecting light beams or enabling the pass-through of light beams. In the case of total reflection, the first color of the color layer 34 will appear. In the case of the pass-through, the color of the second color layer 36 will appear. Refer to the following description.

The third embodiment differs from the first embodiment in the following: the liquid crystals 61 are used in place of the fine particle dispersing medium which is constituted by the transparent fine resin particles 32 and the insulating solvent 31. The liquid crystals 61 are filled in the space between the prism array 21 and the substrate 35 as described above. In FIG. 18, one pixel 15A and one pixel 15B are depicted. The pixel 15A includes an electrode 43 and a prism electrode 41 while the pixel 15B includes an electrode 44 and a prism electrode 42. The orientations of the liquid crystals 61 can be controlled by applying voltages to the electrodes. In order to make the pixels 15A and 15B independent, either the electrode 43 or 44 or the prism electrode 41 or 42 should be separated. One or more prisms are present in each pixel. Further, there is no limit on a size of prisms 22. If each prism is approximately 2 μm, approximately fifty prisms are juxtaposed in one pixel which is approximately 100 μm.

Voltages will be applied to each pixel 15A and each pixel 15B in accordance with image data. For instance, when no voltage is applied to the pixel 15A shown in FIG. 18, the liquid crystals 61 are oriented in parallel with the substrate 35, as predetermined. A refractive index of the liquid crystals 61 is approximately 1.5. When the prism array 21 (made of TiO₂ or the like) has a refractive index of approximately 2.2, light beams will be totally reflected, so that the color of the first color layer 34 on the side facets 23 of the prism array 21 will appear. In other words, the white color will appear. On the contrary, an AC voltage 28 is applied between the electrode 44 and the prism electrode 42 of the pixel 15B. In such a case, the liquid crystals 61 seem to stand upright on the electrode 35 as shown in FIG. 18. A refractive index of the liquid crystals 61 is approximately 1.7. In this state, light beams are not reflected but pass through the border between the prism array 21 and the liquid crystals 61 (in this case, the border means the inclined facets 24). Therefore, the black color of the second color layer 36 on the substrate 35 will appear. The refractive index of the liquid crystals 61 varies in the directions of their longer and shorter axes. This phenomenon is used to vary a difference of refractive indices of the liquid crystal 61 and the prism array 21, thereby selectively showing the color of the first color layer 34 or the color of the second color layer 36.

The third embodiment is effective in selectively showing the colors while the reflective indices are high, and providing a large reflective display unit which offers bright and high contract images.

### Other Embodiments

In the foregoing embodiments, the first color layer 34 is mainly white while the second color layer 36 (or the fine resin particles 132) is black. Alternatively, the first color layer 34 may be black while the second color layer 36 may be white. Further, any colors may be used in combination. When storing colored images, the first color layer 34 may be white while the second color layer may be colored yellow, magenta and cyan, or red, green and blue. Further, the first color layer 34 may be black while the second color layer 36 may be colored yellow, magenta and cyan, or red, green and blue.

Further, the side facets 23 are vertical to the light receiving surface 27 in the foregoing embodiments, Alternatively, the side facets 23 may be vertical to the light receiving facet 25 within a range of ±10° of the vertical. In such a case, if the inclined facets 24 are not reflective state, the color of the first color layer 34 (on the side facet 23) can be practically and sufficiently prevented from appearing on the light receiving surface 27.

The resin particles 32 are used as the second media in the foregoing embodiments. Alternatively, non-organic and positively chargeable particles may be usable.

What is claimed is:

1. A display unit comprising:
a prism layer comprising a light receiving surface, first facets extending along and facing with the light receiving surface, and second facets intersecting with the first facets, the first facets receiving incident light via the light receiving surface and reflecting them in a direction different from the light, and the second facets receiving light reflected by the first facets;
first color layers placed on the second facets;
a medium layer including a first medium that has a first refractive index causing total reflection of the light at a border between the first medium and the first facets, and a second medium that has a second refractive index enabling to pass through the light at a border between the second medium and the first facets, and the first and second media being movable in the medium layer; and
a contact device configured to selectively bringing the first medium or the second medium into contact with the first facet.

2. The display unit as defined in claim 1, wherein the second facets are substantially vertical within a range of ±10° with respect to the light receiving surface.

3. The display unit as defined in claim 1, wherein the second medium is charged; and the contact members include an electrode applying potentials to the prism layer.

4. The display unit as defined in claim 1, wherein the second medium is particles.

5. The display unit as defined in claim 3, wherein the second medium is particles.

6. The display unit as defined in claim 1, wherein the first medium is an insulating solvent; and the second medium is resin particles.

7. The display unit as defined in claim 3, wherein the first medium is an insulating solvent; and the second medium is resin particles.

8. The display unit as defined in claim 1, wherein the first medium is air or an inert gas; and the second media is resin particles.

9. The display unit as defined in claim 3, wherein the first medium is air or an inert gas; and the second media is resin particles.

10. The display unit as defined in claim 1, wherein the first color layers are colored white.

11. The display unit as defined in claim 3, wherein the first color layers are colored white.

12. The display unit as defined in claim 10, wherein the second medium is transparent resin particles.

13. The display unit as defined in claim 12 further comprising a second color layer which faces with the prism layer via the medium layer, and has a color different from the color of the first color layers.

14. The display unit as defined in claim 10, wherein the second medium is resin particles whose color is different from the color of the first color layers.

15. A display unit comprising:
a prism layer comprising a light receiving surface, first facets extending along and facing with the light receiving surface, and second facets intersecting with the first facets, the first facets receiving incident light via the light receiving surface and reflecting them in a direction different from the light, and the second facets receiving light reflected by the first facets;
first color layers placed on the second facets;
a liquid crystal layer in contact with the first facets; and
a switch-over unit varying an orientation of liquid crystal of the liquid crystal layer and selectively putting the first facets in a reflection or pass-through state.

16. The display unit as defined in claim 15, wherein the first color layers are colored white.

17. The display unit as defined in claim 15 further comprising a second color layer which faces with the prism layer via the liquid crystal layer, and has a color different from the color of the first color layers.

18. The display unit as defined in claim 16 further comprising a second color layer which faces with the prism layer via the liquid crystal layer, and has a color different from the color of the first color layers.
